(19) United States
(12) Patent Application Publication
(10) Pub. No.: US 2020/0311114 A1
(43) Pub. Date: Oct. 1, 2020

(54) SYSTEM FOR TOPIC DISCOVERY AND SENTIMENT ANALYSIS ON A COLLECTION OF DOCUMENTS

(71) Applicant: JPMorgan Chase Bank, N.A., New York, NY (US)

(72) Inventors: Ishwadeep SOOD, London (GB); Hani EL SAYYED, Bournemouth (GB); Blair MACKASEY, London (GB); Luiz Fernando Fortes FELIX, Amstelveen (NL); Ashutosh SHAHI, Amstelveen (NL)

(73) Assignee: JPMorgan Chase Bank, N.A., New York, NY (US)

(21) Appl. No.: 16/363,394

(22) Filed: Mar. 25, 2019

(51) Int. Cl. G06F 16/35; G06F 16/93; G06F 16/34

(52) U.S. Cl. CPC G06F 16/355; G06F 17/2785; G06F 16/345; G06F 16/93

(57) ABSTRACT

Systems and methods for analyzing text included in a document in order to identify topics contained within the document and to determine a sentiment associated with each identified topic are provided. The systems and methods may produce a summary report that describes the identified topics and associated sentiments.

### BACKGROUND

### 1. Field of the Disclosure

This technology generally relates to methods of and systems for processing large numbers of documents in order to extract topics and determine sentiments likely expressed toward those topics.

2. Background Information

With the advent of the Internet, electronic news feeds, electronic mail (email), electronic file transfers, and other systems that provide digital data, the sheer amount of digital content that is generated on a daily basis is very large. Consequently consumers of such digital content are increasingly overwhelmed by the amount of data that is available. In many cases, much of the data may not be relevant.

However, certain portions of what is available may be of great interest to a consumer. In addition, in some instances, the overall concepts that are expressed in various portions of the data and a sentiment of an author of the data with respect to those concepts may be of even greater value to the consumer. For example, an equity trader may have a high level of interest in news articles that relate to a particular equity or a field that is related to the particular equity. The equity trader may also have an interest in knowing whether news articles related to a business are generally favorable or generally unfavorable with respect to one or more topics.

In addition to the ever-increasing volume of information, such information may be generally unstructured, and therefore, an analysis of this information may require a great deal of time and effort. Therefore, in view of the above, there is an unmet need for systems for and methods of analyzing documents and other written information to discover topics contained therein and the sentiments expressed with respect to those topics.

### SUMMARY

The present disclosure, through one or more of its various aspects, embodiments, and/or specific features or sub-components, provides, inter alia, various systems, servers, devices, methods, media, programs, and platforms for performing topic discovery and sentiment analysis with respect to documents. The various aspects, embodiments, features, and/or sub-components provide optimized processes of methods of and systems for processing large numbers of documents in order to extract topics and determine a sentiment likely expressed toward those topics

According to an aspect of the present disclosure, a method for analyzing text is provided. The method is implemented by a processor on a computing device. The method includes: obtaining textual data from a first document; applying a pre-processing algorithm to the obtained textual data in order to produce a preprocessed first document; applying a feature engineering algorithm to the preprocessed first document in order to determine a set of feature-engineered data; applying a topic modeling algorithm to the set of feature-engineered data in order to determine a set of topic-modeled data that includes an identification of at least one topic included in the first document; applying a sentiment analysis algorithm to the preprocessed first document in order to obtain a respective sentiment value for each of the identified at least one topic; and generating an output report that includes a summary of the obtained sentiment values for the first document.

The method may further include applying an abstractive summarization algorithm to the obtained textual data in order to obtain a summary of the first document.

The method may further include extracting a plurality of keywords from the obtained textual data.

The pre-processing algorithm may include at least one from among a phrase expansion algorithm that expands a phrase into a multi-word form, a stop word removal algorithm that removes a word that is included in a predetermined list of stop words from the obtained textual data, a lemmatization algorithm that consolidates an inflected form of a word into a base form of the word, a case folding algorithm that removes capitalization from a word, and a punctuation removal algorithm that removes punctuation from the obtained textual data.

The feature engineering algorithm may include at least one from among an N-gram processing algorithm that recognizes a group of words as a single conceptual combination and a named entity detection and removal algorithm that removes a name or an entity identifier from the obtained textual data.

The topic modeling algorithm may include at least one from among a part-of-speech tagging algorithm that assigns a respective part of speech to each word, a filtering algorithm that removes words not identified as nouns, a latent Dirichlet allocation (LDA) algorithm that maps words to topics, and a hyperparameters optimizer algorithm that determines, for at least one topic, a topic coherence measure.

The sentiment analysis algorithm may assign, to each word within a sentence, at least one from among a −1 value that corresponds to a negative sentiment and a +1 value that corresponds to a positive sentiment.

The output report may include a list of topics obtained from among the identified at least one topic and, for each respective topic included in the list, a mean sentiment score that is determined based on an arithmetic aging of the assigned values for words that relate to the respective topic.

When the first document is published periodically, the generation of the output report may include: determining a list of topics obtained from among the identified at least one topic and at least two dates that correspond to publications of the first document; for each respective topic included in the list, determining a respective mean sentiment score by computing, an arithmetic average of the assigned values for words that relate to the respective topic; for each respective one of the at least two dates, computing a respective z-score for a current publication of the first document that corresponds to a standard deviation measurement with respect to the determined respective mean sentiment score; and including the list of topics, each of the at least two dates, and each respective z-score in the output report.

The method may further include applying an abstractive summarization algorithm to the obtained textual data in order to obtain a summary of the first document; extracting a plurality of keywords from the obtained textual data; and including the summary and each of the extracted plurality of keywords in the output report

According to another aspect of the present disclosure, a computing device configured to implement an execution of a method for analyzing text is provided. The computing device includes a display screen, a processor, a memory, and a communication interface coupled to each of the processor, the memory, and the display screen. The processor is configured to: obtain textual data from a first document; apply a pre-processing algorithm to the obtained textual data in order to produce a preprocessed first document; apply a feature engineering algorithm to the preprocessed first document in order to determine a set of feature-engineered data; apply a topic modeling algorithm to the set of feature-engineered data in order to determine a set of topic-modeled data that includes an identification of at least one topic included in the first document; apply a sentiment analysis algorithm to the preprocessed first document in order to obtain a respective sentiment value for each of the identified at least one topic; and generate an output report that includes a summary of the obtained sentiment values for the first document, the generated output being displayable on the display screen.

The processor may be further configured to apply an abstractive summarization algorithm to the obtained textual data in order to obtain a summary of the first document.

The processor may be further configured to extract a plurality of keywords from the obtained textual data.

The pre-processing algorithm may include at least one from among a phrase expansion algorithm that expands a phrase into a multi-word form, a stop word removal algorithm that removes a word that is included in a predetermined list of stop words from the obtained textual data, a lemmatization algorithm that consolidates an inflected form of a word into a base form of the word, a case folding algorithm that removes capitalization from a word, and a punctuation removal algorithm that removes punctuation from the obtained textual data.

The feature engineering algorithm may include at least one from among an N-gram processing algorithm that recognizes a group of words as a single conceptual combination and a named entity detection and removal algorithm that removes a name or an entity identifier from the obtained textual data.

The topic modeling algorithm may include at least one from among a part-of-speech tagging algorithm that assigns a respective part of speech to each word, a filtering algorithm that removes words not identified as nouns, a latent Dirichlet allocation (LDA) algorithm that maps words to topics, and a hyperparameters optimizer algorithm that determines, for at least one topic, a topic coherence measure.

The sentiment analysis algorithm may assign, to each word within a sentence, at least one from among a −1 value that corresponds to a negative sentiment and a +1 value that corresponds to a positive sentiment.

The output report may include a list of topics obtained from among the identified at least one topic and, for each respective topic included in the list, a mean sentiment score that is determined based on an arithmetic averaging of the assigned values for words that relate to the respective topic.

When the first document is published periodically, the processor may be further configured to generate the output report by: determining a list of topics obtained from among the identified at least one topic and at least two dates that correspond to publications of the first document; for each respective topic included in the list, determining a respective mean sentiment score by computing, an arithmetic average of the assigned values for words that relate to the respective topic; for each respective one of the at least two dates, computing a respective z-score for a current publication of the first document that corresponds to a standard deviation measurement with respect to the determined respective mean sentiment score; and including the list of topics, each of the at least two dates, and each respective z-score in the output report.

The processor may be further configured to: apply an abstractive summarization algorithm to the obtained textual data in order to obtain a summary of the first document; extract a plurality of keywords from the obtained textual data; and include the summary and each of the extracted plurality of keywords in the output report.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system for analyzing text in order to extract topics and determine a sentiment likely expressed toward those topics.

FIG. 2 illustrates an exemplary diagram of a network environment.

FIG. 3 shows an exemplary system for processing large numbers of documents in order to extract topics and determine a sentiment likely expressed toward those topics.

FIG. 4 is a flowchart of an exemplary method for processing large numbers of documents in order to extract topics and determine a sentiment likely expressed toward those topics.

FIG. 5A illustrates an exemplary string of textual data.

FIG. 5B illustrates an example output of a pre-processing algorithm and a feature engineering algorithm as applied to the string of textual data illustrated in FIG. 5A, according to an exemplary embodiment.

FIG. 6 illustrates an example of an output report that includes a result of a method for processing large numbers of documents in order to extract topics and determine a sentiment likely expressed toward those topics, according to an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein, The instructions in some examples include executable code that, when executed by one or more processors, cause the processors to carry out steps necessary to implement the methods of the examples of this technology that are described and illustrated herein.

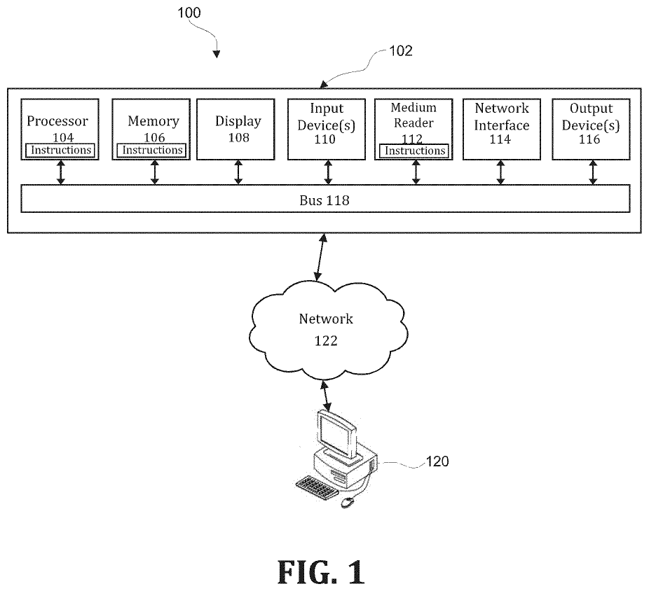

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server oar as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term non-transitory is to be interpreted not as an eternal characteristic of a state, but as a characteristic of a state that will last for a period of time. The term non-transitory specifically disavows fleeting characteristics such as characteristics of a particular carrier wave or signal or other forms that exist only transitorily in any place at any time, The processor 104 is an article of manufacture and/or a machine component. The processor 104 is configured to execute software instructions in order to perform functions as described in the various embodiments herein. The processor 104 may be a general purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device, The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term non-transitory is to be interpreted not as an eternal characteristic of a state, but as a characteristic of a state that last for a period of time. The term non-transitory specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a video display 108, such as a liquid crystal display (LCD), an organic light emitting diode ((SLED), a flat panel display, a solid state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102, Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive, Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionality as described herein, and a processor described herein may be used to support a virtual processing environment.

As described herein, various embodiments provide optimized processes of analyzing large numbers of documents in order to extract topics and determine a sentiment likely expressed toward those topics.

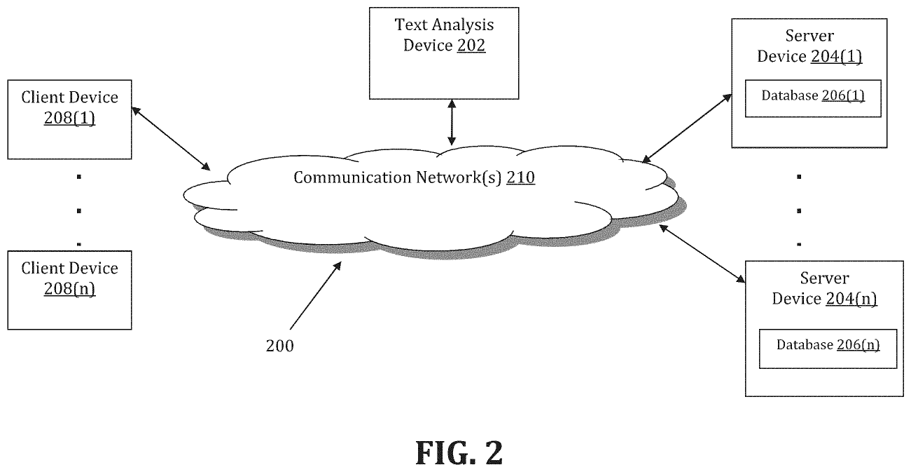

Referring to FIG. 2, a schematic of an exemplary network environment 200 for implementing a method for processing large numbers of documents in order to extract topics and determine a sentiment likely expressed toward those topics is illustrated. In an exemplary embodiment, the method is executable on any networked computer platform, such as, for example, a wireless mobile communication device, i.e., a smart phone.

The conducting of the commercial transaction involving a gratuity may be implemented by a Text Analysis (TA) device 202. The TA device 202 may be the same or similar to the computer system 102 as described with respect to FIG. 1. The TA device 202 may store one or more applications that can include executable instructions that, when executed by the TA device 202, cause the TA device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the TA device 202 itself, may be located in virtual server(s) running in a cloud-based computing environment rather than being tied to one or more specific physical network computing devices. Also, the application(s) may be running in one or more virtual machines (VMs) executing on the TA device 202. Additionally, in one or more embodiments of this technology, virtual machine(s) running on the TA device 202 may be managed or supervised by a hypervisor.

In the network environment 200 of FIG. 2, the TA device 202 is coupled to a plurality of server devices 204(1)-204(n) that hosts a plurality of databases 206(1)-206(n), and also to a plurality of client devices 208(1)-208(n) via communication network(s) 210. A communication interface of the TA device 202, such as the network interface 114 of the computer system 102 of FIG. 1, operatively couples and communicates between the TA device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the TA device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and TA devices that efficiently process large numbers of documents in order to extract topics and determine a sentiment likely expressed toward those topics.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The TA device 202 may be a standalone device or integrated with one or more other devices or apparatuses, such as one or more of the server devices 204(1)-204(n), for example. In one particular example, the TA device 202 may include or be hosted by one of the server devices 204(1)-204(n), and other arrangements are also possible. Moreover, one or more of the devices of the TA device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the TA device 202 via the communication net k(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store documents and other sources of textual data, historical data that relates to topics, and historical data that relates to sentiments.

Although the server devices 204(1)-204(n) are illustrated as single devices, one or more actions of each of the server devices 204(1)-204(n) may be distributed across one or more distinct network computing devices that together comprise one or more of the server devices 204(1)-204(n), Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can facilitate the execution of a web application. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example, In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the TA device 202 via the communication network(s) 210 in order to communicate user requests. The client devices 208(1)-208(n) may further include, among other features, a display device, such as a display screen or touchscreen, and/or an input device, such as a keyboard, for example.

Although the exemplary network environment 200 with the TA device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the TA device 202, the server devices 204(1)-204(n), or the client devices 208(1)-208(n), for example, may be configured to operate as virtual instances on the same physical machine. In other words, one or more of the TA device 202, the server devices 204(1)-204(n), or the client devices 208(1)-208(n) may operate on the same physical device rather than as separate devices communicating through communication network(s) 210. Additionally, there may be more or fewer TA devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

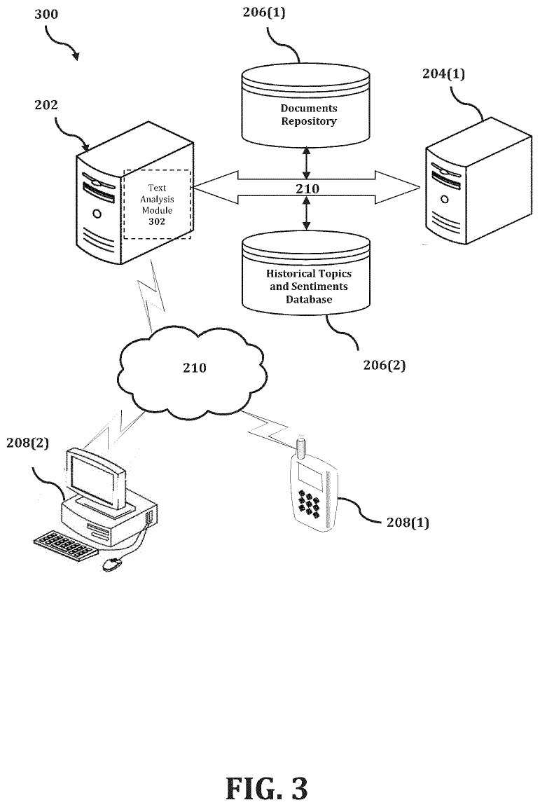

The TA device 202 is described and shown in FIG. 3 as including a text analysis module 302, although it may include other modules, databases, or applications, for example. As will be described below, the text analysis module 302 is configured to process large numbers of documents in order to extract topics and determine sentiments likely expressed toward those topics in an automated, efficient, scalable, and reliable manner. Based on textual information that is contained in a document or in a corpus of documents, the text analysis module 302 obtains textual data that relates to the document(s), and then processes this information to extract topics and determine sentiments with respect to those topics.

An exemplary process 300 for processing large numbers of documents in order to extract topics and determine sentiments likely expressed toward those topics by utilizing the network environment of FIG. 2 is shown as being executed in FIG. 3. Specifically, a first client device 208(1) and a second client device 208(2) are illustrated as being in communication with TA device 202. In this regard, the first client device 208(1) and the second client device 208(2) may be clients of the TA device 202 and are described herein as such. Nevertheless, it is to be known and understood that the first client device 208(1) and/or the second client device 208(2) need not necessarily be clients of the TA device 202, or any entity described in association therewith herein Any additional or alternative relationship may exist between either or both of the first client device 208(1) and the second client device 208(2) and the TA device 202, or no relationship may exist.

Further, TA device 202 is illustrated as being able to access a documents repository 206(1) and a historical topics and sentiments database 206(2). The automatic text analysis module 302 may be configured to access these databases for implementing a process for analyzing large numbers of documents in order to extract topics and determine sentiments likely expressed toward those topics.

The first client device 208(1) may be, for example, a smart phone. Of course, the first client device 208(1) may be any additional device described herein. The second client device 203(2) may be, for example, a personal computer (PC). Of course, the second client device 208(2) may also be any additional device described herein.

The process may be executed via the communication networks) 210, which may comprise plural networks as described above. For example, in an exemplary embodiment, either or both of the first client device 208(1) and the second client device 208(2) may communicate with the TA device 202 via broadband or cellular communication. Of course, these embodiments are merely exemplary and are not limiting or exhaustive.

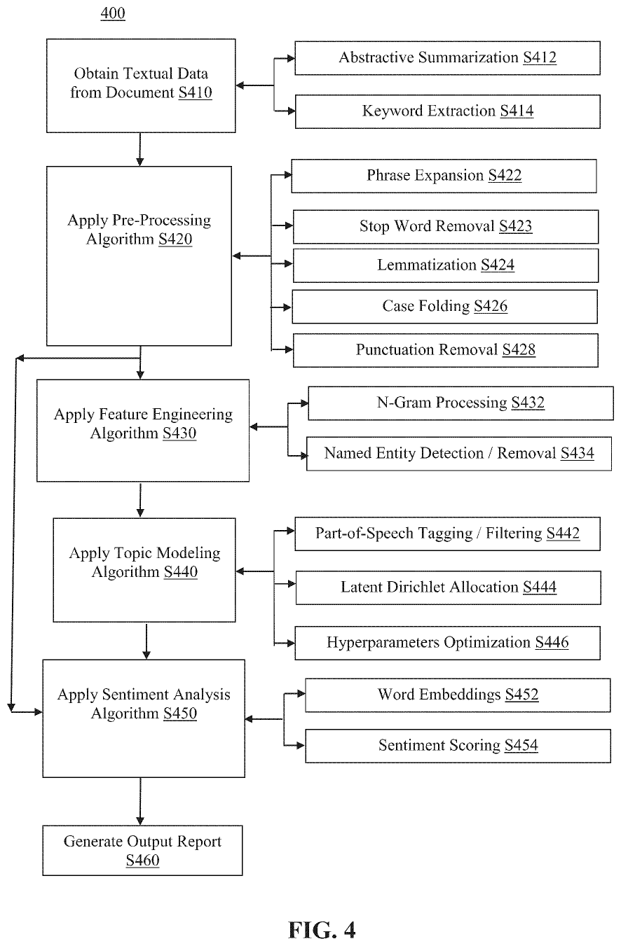

Upon being started, the text analysis module 302 executes a process for analyzing one or more documents in order to extract topics and determine sentiments likely expressed toward those topics. An exemplary process for analyzing one or more documents in order to extract topics and determine sentiments likely expressed toward those topics is generally indicated at flowchart 400 in FIG. 4.

In the process 400 of FIG. 4, at step S410, textual data is obtained from one or more documents. The data may include textual data that is received from a plurality of sources, such as, for example, any of data downloads, emails, scanned documents, web pages, and/or text data files. In an exemplary embodiment, the data may represent a large number of discrete documents, such as, for example, at least one hundred (100) discrete documents or at least one thousand (1000) discrete documents. The data may be organized by document, such that each document may be analyzed and reported on separately as desired, and such that each document may be stored in the documents repository 206(1).

In an exemplary embodiment, an abstractive summarization algorithm S412 may selectively be applied to the obtained textual data in order to obtain a summary of a given document. In an exemplary embodiment, a keyword extraction algorithm S414 may be selectively applied to the obtained textual data in order to identify a list of keywords that are contained within a particular document.

At step S420, the obtained textual data is processed by one or more pre-processing algorithms. In an exemplary embodiment, the pre-processing algorithm S420 may include any of a phrase expansion algorithm S422, a stop word removal algorithm S423, a lemmatization algorithm S424, a case folding algorithm S426, and a punctuation removal algorithm S428.

In an exemplary embodiment, the phrase expansion algorithm S422 is applied to the obtained textual data. The phrase expansion algorithm S422 expands a common phrase into its multi-word form. For example, a phrase expansion algorithm may expand the word can t into can not As another example, it s would be expanded to it is.

In an exemplary embodiment, the stop word removal algorithm S423 is applied to the obtained textual data. The stop word removal algorithm S423 removes stop words, which are generally short function words, from the obtained textual data.

Examples, without limitation, of stop words include the following: the, is, at, which, and on.

In an exemplary embodiment, the lemmatization algorithm S424 is applied to the remaining textual data. The lemmatization algorithm S424 consolidates inflected forms of a word into the base form of the word. In an exemplary embodiment, lemmatization is applied in conjunction with a part-of-speech tagging function. Part-of-speech tagging associates words with their functions in a phrase. For example, in the phrase he saw the dog cross the road, the word saw is a verb. Therefore, a part-of-speech tagging function applies this tag in order to enable the lemmatization algorithm S424 to identify saw as inflection of the base word see. As another example, part-of-speech tagging may identify the word as a noun that refers to a tool. As such, applying the lemmatization algorithm S424 would result in the word saw remaining in the text, instead of replacing it with see.

In an exemplary embodiment, the case folding algorithm S426 is applied to the obtained textual data. The case folding algorithm S426 removes capitalization from a word when such a removal does not change the meaning of the word. For example, the first word in a sentence may be Can. The case folding algorithm S426 would convert Can to can, because the conversion does not change the meaning of the word. Conversely, as another example, if the text is US, the case folding algorithm S426 would not remove the capitalization, because the word us has a completely different meaning than the term US.

In an exemplary embodiment, the punctuation removal algorithm S428 is applied to the obtained textual data. The punctuation removal algorithm S428 removes punctuation from the obtained textual data. In an exemplary embodiment, the punctuation removal algorithm S428 may also remove numeric values from the obtained textual data.

Thus, the output of the pre-processing algorithm S420 is a processed version of the obtained textual data that has punctuation, capitalization, stop words, and inflections removed.

At step S430, the preprocessed textual data is further processed by one or more feature engineering algorithms. The feature engineering function S434 removes extraneous material in order to distill the textual data into a more concise dataset. In an exemplary embodiment, the feature engineering algorithm S430 may include any of an N-Gram processing algorithm S432 and a named entity detection and removal algorithm S434.

In an exemplary embodiment, the N-Gram processing algorithm S432 analyzes the text to determine groups of words that are intended to form a contiguous combination, and combines those groups together. For example, the words European Central Bank may be recognized as forming a combination that identifies an entity. As such, the N-Gram processing algorithm S432 would to combine the words European, Central, and Bank into a group that is interpreted as a single term (European Central Bank) that has a meaning that may be different than the meanings of the words when interpreted separately. In this example, the term European Central Bank refers to the name of a known business entity.

In an exemplary embodiment, the named entity detection and removal algorithm S434 identifies words or multi-word terms (as identified by the N-Gram processing algorithm S432) that represent entities or persons. For example, as described above, the words European Central Bank may be combined into a phrase that represents a banking institution. Once identified, the named entity detection and removal algorithm S434 removes these words from the remaining textual data because they do not contribute to the analysis of the topics that are present in the document.

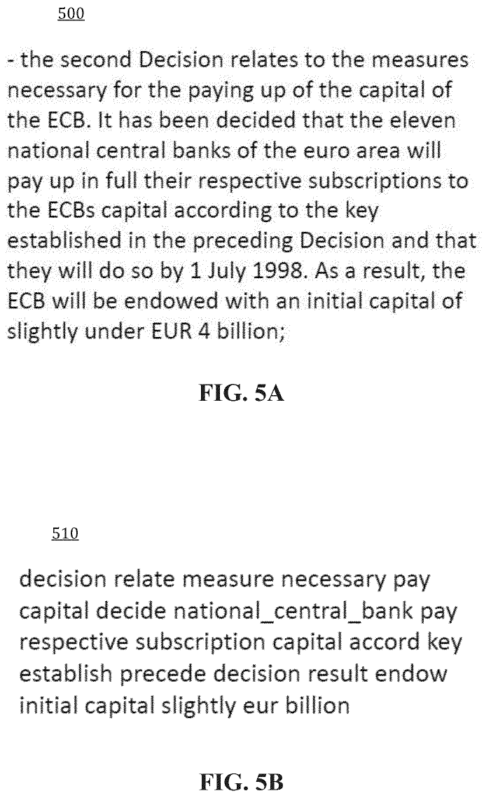

Referring also to FIGS. 5A and 5B, FIG. 5A illustrates an exemplary string of textual data, and FIG. 5B illustrates an example output of the pre-processing algorithm S420 and the feature engineering algorithm S430 as applied to the string of textual data illustrated in FIG. 5A. In particular, as a result of the pre-processing algorithm S420, stop words such as to, the, and that have been removed; the inflected form relates has been converted to the base form relate, and the inflected form decided has been converted to the base form decide; the capitalization of Decision has been removed in two instances; and the punctuation and numeric forms, such as second and eleven, have been removed. Further, as a result of the feature engineering algorithm S430, the words national, central, and banks have been combined into a single term; and entities such as ECB have been removed.

The output of the feature engineering algorithm S430 is then provided to the topic modeling algorithm S440. The topic modeling algorithm S440 receives words and applies topic analysis functions in order to identify the concepts and topics that are present in the obtained textual data. In an exemplary embodiment, the topic modeling algorithm S440 may include any of a part-of-speech tagging and filtering algorithm S442; a Latent Dirichlet Allocation (LDA) algorithm S444; and a hyperparameters optimization algorithm S446.

In an exemplary embodiment, the text that is included in the output from the feature engineering algorithm S430 may be provided to the topic modeling algorithm S440 as a collection of words without regard to the relative positions of the words within the documents from which the textual data was originally obtained. This method of providing words without consideration of sentence structure is referred to as a bag of words (BOW) methodology. Alternatively, in another exemplary embodiment, a term frequency inverse document frequency (TF-IDF) algorithm may applied to the textual data, sorted by documents that appear in the data. The output of the TF-IDF algorithm may then be provided to the topic modeling algorithm S440.

In an exemplary embodiment, the part-of-speech tagging and filtering algorithm S442 determines a respective part of speech for each word, and then removes words not identified as nouns. The LDA algorithm S444 is then applied to the filtered textual data. In an exemplary embodiment, the LDA algorithm S444 maps words to topics, and then maps the topics to documents that are included in the original set of obtained textual data. The result of the LDA algorithm S444 is a mapping of the topics identified in each document that was part of the original input data and a listing of words that are mapped to those topics as being related. The LDA algorithm S444 further determines a respective rating of an importance of each word in a document.

Once the LDA algorithm S444 has identified topics by document, those topics are processed by the hyperparameters optimization algorithm S446. In an exemplary embodiment, the hyperparameters optimization algorithm S446 is configured to test combinations of topics in order to determine a number of topics and a selection of topics that result in the most favorable topic coherence measure. In addition, the hyperparameters optimization algorithm S446 tests analysis combinations in order to determine whether to use TF-IDF or BOW, whether or not to remove entities, whether or not to remove all nouns, and other types of combinations, in order to determine a result with the most favorable topic coherence measure.

In an exemplary embodiment, the output of the topic modeling algorithm S440 provides a resulting listing of words that is mapped by topic and by document subject. Then, at step S450, the output of the pre-processing algorithm S420 and the output of the topic modeling algorithm are provided to the sentiment analysis algorithm. In an exemplary embodiment, the sentiment analysis algorithm S450 includes a word embeddings algorithm S452 and a sentiment scoring algorithm S454.

In an exemplary embodiment, the word embeddings algorithm S452 quantifies and categorizes semantic similarities of words. The quantification and the categorization are based on the distribution of such words in large samples of language data. For example, words such as apples and oranges may be categorized as being semantically similar to words such as eaten and ripe.

In an exemplary embodiment, the sentiment scoring algorithm S454 uses a lexicon of words for which each word is generally associated with a known sentiment in order to predict a sentiment that should be associated with a word or phrase found in the documents for which words have been mapped by topic. In an exemplary embodiment, the lexicon of words and the corresponding sentiments may be stored in the historical topics and sentiments database 206(2). In an exemplary embodiment, the sentiment scoring algorithm S454 assigns, to each word in a particular sentence, a numeric score that ranges from −1 to +1, with −1 representing a negative sentiment and +1 representing a positive sentiment. The numeric score may be derived by using a vector space analysis of the words relative to words associated with known sentiments that are included in the lexicon. In an exemplary embodiment, a word classifier function may be applied in order to produce a positive or negative representation of the sentiment value expressed by a word. The sentiment values of each word in a sentence are then averaged in order to determine an average sentiment expressed by the analyzed sentence. Then, the output of the topic modeling algorithm S450 may be used to ascertain which sentences are associated with which topic. As a result, a sentiment calculation may be performed on a topic-by-topic basis by combining the determined average sentiment values for sentences that are associated with a particular topic.

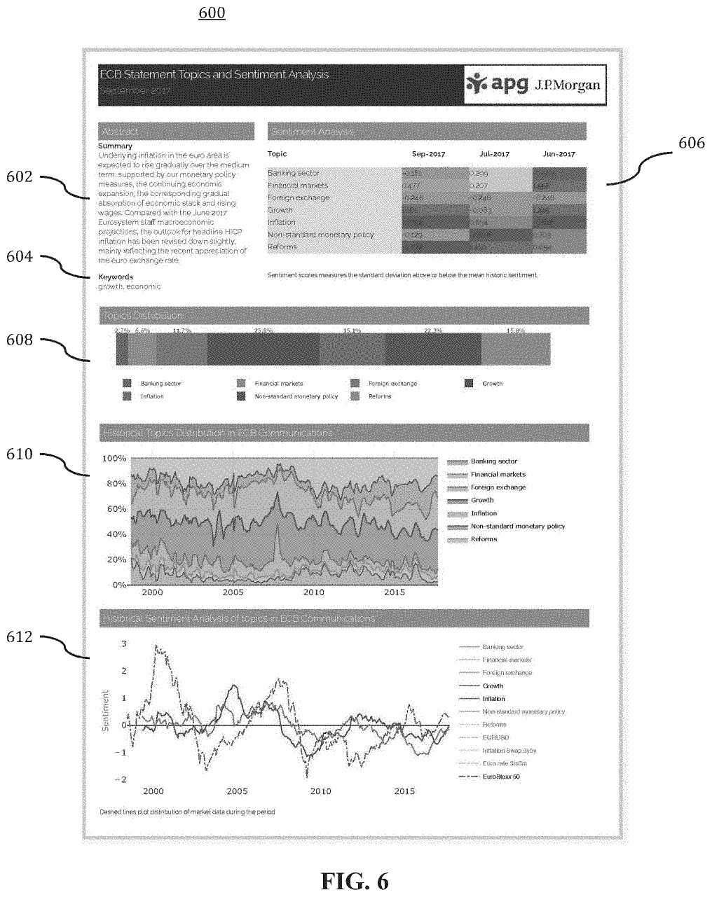

At step S460, an output report is generated. In an exemplary embodiment, the output report summarizes the sentiments identified in the analyzed documents. Referring to FIG. 6, an example of an output report 600 that includes a result of a method for processing large numbers of documents in order to extract topics and determine a sentiment likely expressed toward those topics, in accordance with one or more exemplary embodiments.

As illustrated in FIG. 6, the output report 600 may include a summary 602 of a document, In an exemplary embodiment, the abstractive summarization algorithm S412 may be applied to the obtained textual data in order to obtain the summary 702. As also illustrated in FIG. 6, the output report 600 may also include a list of keywords 604. In an exemplary embodiment, the keyword extraction algorithm S414 may applied to the obtained textual data in order to obtain the list of keywords 604.

In an exemplary embodiment, although a particular document may contain many topics, the output report 600 may include a section 606 that lists key topics. These key topics may be selected based upon the interests of the intended audience of the output report 600. In instances in which the document analyzed is a serial or periodical publication, the report 600 may also include historical data that illustrates changes each time the document is published. For example, in an exemplary embodiment, the document being analyzed may be published on a monthly basis. However, in other exemplary embodiments, publications that are produced with greater or lesser frequency may be analyzed. In the illustrated embodiment as shown in FIG. 6, the sentiments expressed in the analyzed document with regard to the key topics are displayed as z-scores, each of which is calculated as a standard deviation relative to a mean score for each sentiment each month that a document has previously been analyzed. The calculation of a z-score results in an indication of a positive or negative change in the sentiment score. In an exemplary embodiment, the output report 600 may include a color coding for each z-score such that a favorable or unfavorable change in sentiment may be easily determined from the report 700 by observing the displayed color.

The report 600 may also include a chart 608 that indicates a distribution of topics that are contained in the analyzed document. The report 600 may also include a historical distribution of topics 610 when the document is serial or periodical in nature. Such a historical distribution 610 allows a viewer to observe trends in the amounts of content associated with the various topics. In addition to a historical distribution 610, the report 600 may also include a graphical depiction of the sentiment analysis history 612 for each topic. This illustration may indicate the variations in sentiment over the period of time displayed.

In an exemplary embodiment, the report 600 may be displayed on a graphical user interface that enables a user to interact with the display in order to select parameters for the report. For example, a user may be able to select which topics to include in the key topics section 606, the topics distribution chart 608, the historical distribution of topics 610, and/or the sentiment analysis history 612. As another example, a user may be able to specify a time frame of interest for each section of the report 600.

Accordingly, with this technology, an optimized process for analyzing documents in order to extract topics and determine sentiments likely expressed toward those topics is provided, The optimized process enables a user to efficiently and automatically process large numbers of documents in order to extract topics and determine sentiments likely expressed toward those topics.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term computer-readable medium includes a single medium or multiple media, such as a centralized or distributed database, and/or associated caches and servers that store one or more sets of instructions, The term computer readable medium shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived frond the disclosure, such that structural and logical substitutions and changes may be made without departing from the scope of the disclosure. Additionally, the illustrations are merely representational and may not be drawn to scale, Certain proportions within the illustrations may be exaggerated, while other proportions may be minimized, Accordingly, the disclosure and the figures are to be regarded as illustrative rather than restrictive.

One or more embodiments of the disclosure may be referred to herein, individually and/or collectively, by the term invention merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for analyzing text, the method being implemented by a processor on a computing device, the method comprising:
obtaining textual data from a first document;
applying a pre-processing algorithm to the obtained textual data in order to produce a preprocessed first document;
applying a feature engineering algorithm to the preprocessed first document in order to determine a set of feature-engineered data;
applying a topic modeling algorithm to the set of feature-engineered data in order to determine a set of topic-modeled data that includes an identification of at least one topic included in the first document;
applying a sentiment analysis algorithm to the preprocessed first document in order to obtain a respective sentiment value for each of the identified at least one topic; and
generating an output report that includes a summary of the obtained sentiment values for the first document.

2. The method of claim 1, further comprising applying an abstractive summarization algorithm to the obtained textual data in order to obtain a summary of the first document.

3. The method of claim 1, further comprising extracting a plurality of keywords from the obtained textual data.

4. The method of claim 1, wherein the pre-processing algorithm includes at least one from among a phrase expansion algorithm that expands a phrase into a multi-word form, a stop word removal algorithm that removes a word that is included in a predetermined list of stop words from the obtained textual data, a lemmatization algorithm that consolidates an inflected form of a word into a base form of the word, a case folding algorithm that removes capitalization from a word, and a punctuation removal algorithm that removes punctuation from the obtained textual data.

5. The method of claim 1, wherein the feature engineering algorithm includes at least one from among an N-gram processing algorithm that recognizes a group of words as a single conceptual combination and a named entity detection and removal algorithm that removes a name or an entity identifier from the obtained textual data.

6. The method of claim 1, wherein the topic modeling algorithm includes at least one from among a part-of-speech tagging algorithm that assigns a respective part of speech to each word, a filtering algorithm that removes words not identified as nouns, a latent Dirichlet allocation (LDA) algorithm that maps words to topics, and a hyperparameters optimizer algorithm that determines, for at least one topic, a topic coherence measure.

7. The method of claim 1, wherein the sentiment analysis algorithm assigns, to each word within a sentence, at least one from among a −1 value that corresponds to a negative sentiment and a +1 value that corresponds to a positive sentiment.

8. The method of claim 1, wherein the output report includes a list of topics obtained from among the identified at least one topic and, for each respective topic included in the list, a mean sentiment score that is determined based on an arithmetic averaging of the assigned values for words that relate to the respective topic.

9. The method of claim 1 wherein when the first document is published periodically, the generating the output report includes:
determining a list of topics obtained from among the identified at least one topic and at least two dates that correspond to publications of the first document;
for each respective topic included in the list, determining a respective mean sentiment score by computing, an arithmetic average of the assigned values for words that relate to the respective topic;
for each respective one of the at least two dates, computing a respective z-score for a current publication of the first document that corresponds to a standard deviation measurement with respect to the determined respective mean sentiment score; and
including the list of topics, each of the at least two dates, and each respective z-score in the output report.

10. The method of claim 9, further comprising:
applying an abstractive summarization algorithm to the obtained textual data in order to obtain a summary of the first document;
extracting a plurality of keywords from the obtained textual data; and
including the summary and each of the extracted plurality of keywords in the output report.

11. A computing device configured to implement an execution of a method for analyzing text, the computing device comprising:
a display screen;
a processor;
a memory; and
a communication interface coupled to each of the processor, the memory, and the display screen,
wherein the processor is configured to:
obtain textual data from a first document;
apply a pre-processing algorithm to the obtained textual data in order to produce a preprocessed first document;
apply a feature engineering algorithm to the preprocessed first document in order to determine a set of feature-engineered data;
apply a topic modeling algorithm to the set of feature-engineered data in order to determine a set of topic-modeled data that includes an identification of at least one topic included in the first document;
apply a sentiment analysis algorithm to the preprocessed first document in order to obtain a respective sentiment value for each of the identified at least one topic; and
generate an output report that includes a summary of the obtained sentiment values for the first document, the generated output being displayable on the display screen.

12. The computing device of claim 11, wherein the processor is further configured to apply an abstractive summarization algorithm to the obtained textual data in order to obtain a summary of the first document.

13. The computing device of claim 11, wherein the processor is further configured to extract a plurality of keywords from the obtained textual data.

14. The computing device of claim 11, wherein the pre-processing algorithm includes at least one from among a phrase expansion algorithm that expands a phrase into a multi-word form, a stop word removal algorithm that removes a word that is included in a predetermined list of stop words from the obtained textual data, a lemmatization algorithm that consolidates an inflected form of a word into a base form of the word, a case folding algorithm that removes capitalization from a word, and a punctuation removal algorithm that removes punctuation from the obtained textual data.

15. The computing device of claim 11, wherein the feature engineering algorithm includes at least one from among an N-gram processing algorithm that recognizes a group of words as a single conceptual combination and a named entity detection and removal algorithm that removes a name or an entity identifier from the obtained textual data.

16. The computing device of claim 11, wherein the topic modeling algorithm includes at least one from among a part-of-speech tagging algorithm that assigns a respective part of speech to each word, a filtering algorithm that removes words not identified as nouns, a latent Dirichlet allocation (LDA) algorithm that maps words to topics, and a hyperparameters optimizer algorithm that determines, for at least one topic, a topic coherence measure.

17. The computing device of claim 11, wherein the sentiment analysis algorithm assigns, to each word within a sentence, at least one from among a −1 value that corresponds to a negative sentiment and a +1 value that corresponds to a positive sentiment.

18. The computing device of claim 11, wherein the output report includes a list of topics obtained from among the identified at least one topic and, for each respective topic included in the list, a mean sentiment score that is determined based on an arithmetic averaging of the assigned values for words that relate to the respective topic.

19. The computing device of claim 11, wherein when the first document is published periodically, the processor is further configured to generate the output report by:
determining a list of topics obtained from among the identified at least one topic and at least two dates that correspond to publications of the first document;
for each respective topic included in the list, determining a respective mean sentiment score by computing, an arithmetic average of the assigned values for words that relate to the respective topic;
for each respective one of the at least two dates, computing a respective z-score for a current publication of the first document that corresponds to a standard deviation measurement with respect to the determined respective mean sentiment score; and
including the list of topics, each of the at least two dates, and each respective z-score in the output report.

20. The computing device of claim 19, wherein the processor is further configured to;
apply an abstractive summarization algorithm to the obtained textual data in order to obtain a summary of the first document;
extract a plurality of keywords from the obtained textual data; and
include the summary and each of the extracted plurality of keywords in the output report.
